(19) United States
(12) Patent Application Publication
(10) Pub. No.: US 2026/0296008 A1
(43) Pub. Date: Oct. 1, 2026

(54) CHANNEL MEMBER, LIQUID DISCHARGE HEAD, LIQUID DISCHARGE APPARATUS, AND THREE-DIMENSIONAL FABRICATION APPARATUS

(71) Applicant: Satoru YOSHIDA, Kanagawa (JP)

(72) Inventor: Satoru YOSHIDA, Kanagawa (JP)

(21) Appl. No.: 19/560,200

(22) Filed: Mar. 9, 2026

(30) Foreign Application Priority Data
Mar. 25, 2025 (JP) 2025-049443
Jul. 23, 2025 (JP) 2025-123057

(51) Int. Cl. B41J 2/14; B29C 64/165; B29C 64/209; B29C 64/295; B33Y 30/00; B41J 29/00; F16F 1/18

(52) U.S. Cl. CPC B41J 2/14233; B29C 64/165; B29C 64/209; B29C 64/295; B33Y 30/00; B41J 29/00; F16F 1/18; F16F 2238/022

(57) ABSTRACT

A channel member includes: a common channel member including: a common channel; and an attachment portion, in the common channel member; and a heater having a heat generating surface to transfer heat from the heat generating surface to the common channel member; and a heater holder to hold the heater, wherein the heater holder holding the heater is attached to the attachment portion of the common channel member.

### CROSS-REFERENCE TO RELATED APPLICATIONS

This patent application is based on and claims priority pursuant to 35 U.S.C. § 119(a) to Japanese Patent Application No. 2025-049443, filed on Mar. 25, 2025, in the Japan Patent Office, and Japanese Patent Application No. 2025-123057, filed on Jul. 23, 2025, in the Japan Patent Office, the entire disclosure of which is hereby incorporated by reference herein.

### BACKGROUND

### Technical Field

The present embodiment relates to a channel member, a liquid discharge head, a liquid discharge apparatus, and a three-dimensional fabrication apparatus.

### Related Art

As a liquid discharge head that discharges liquid, there is a liquid discharge head including a heater that heats the head in the vicinity of a common channel.

### SUMMARY

The present disclosure disclosed herein provides a channel member includes: a common channel member including: a common channel; and an attachment portion, in the common channel member; and a heater having a heat generating surface to transfer heat from the heat generating surface to the common channel member; and a heater holder to hold the heater, wherein the heater holder holding the heater is attached to the attachment portion of the common channel member.

### BRIEF DESCRIPTIONS OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is an exploded perspective explanatory view of a liquid discharge head according to a first embodiment;

FIG. 2 is an explanatory cross-sectional view taken along a direction orthogonal to a nozzle array direction corresponding to a line X1-X1 of the liquid discharge head of FIG. 1;

FIG. 3-1 is a plan view schematically illustrating a common channel member;

FIGS. 3-2A and 3-2B are plan views schematically illustrating a heater;

FIGS. 4A and 4B are views illustrating an example of a heater holder;

FIGS. 5A and 5B are plan views illustrating an attachment member obtained by attaching the heater to the heater holder;

FIG. 6 is a plan view illustrating a state in which the attachment member is set in openings of a common channel member;

FIGS. 7A and 7B are plan views illustrating, as an example, a heater holder according to a second embodiment;

FIG. 8 is an explanatory cross-sectional view illustrating a liquid discharge head according to a third embodiment;

FIG. 9 is an explanatory schematic view of an example of a liquid discharge apparatus;

FIG. 10 is an explanatory plan view of an example of a head unit of the liquid discharge apparatus;

FIG. 11 is an explanatory plan view of a main part of another example of the liquid discharge apparatus;

FIG. 12 is an explanatory side view of a main part of the liquid discharge apparatus;

FIG. 13 is an explanatory plan view of a main part of another example of a liquid discharge unit; and

FIG. 14 is an explanatory front view of still another example of the liquid discharge unit.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, embodiments of a channel member, a liquid discharge head, a liquid discharge apparatus, and a three-dimensional fabrication apparatus will be described in detail with reference to the accompanying drawings.

### First Embodiment

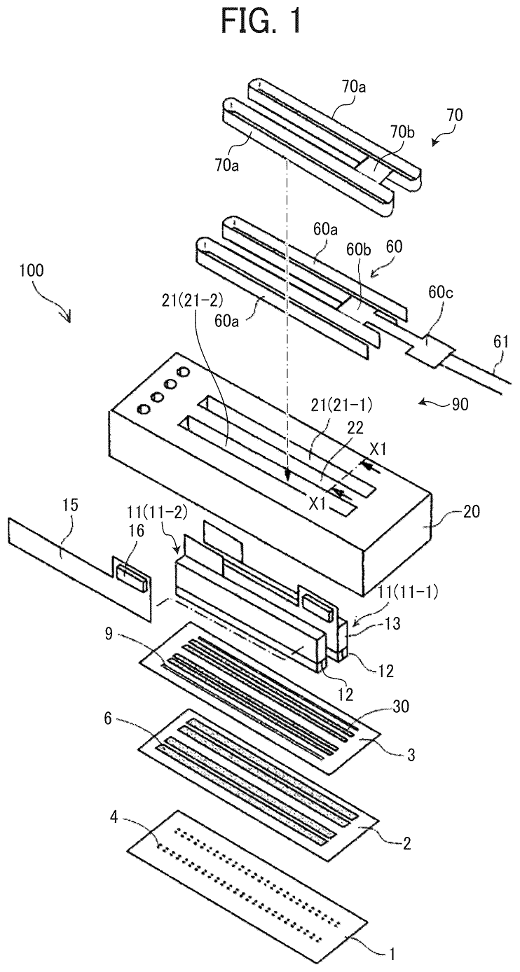

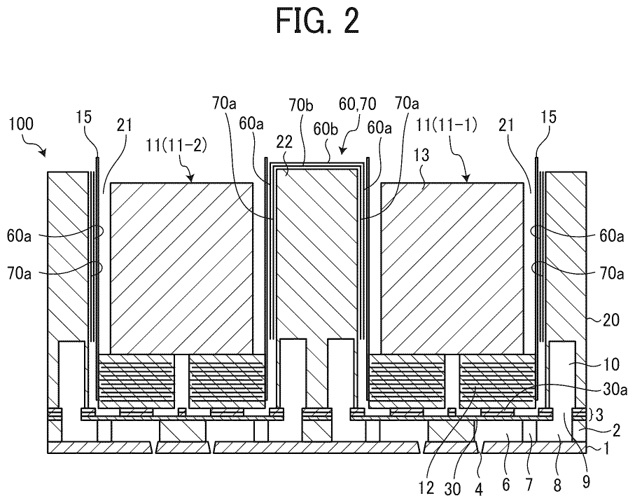

FIG. 1 is an exploded explanatory perspective view of a liquid discharge head 100 according to a first embodiment. FIG. 2 is an explanatory cross-sectional view taken along a direction orthogonal to a nozzle array direction corresponding to a line X1-X1 of the liquid discharge head 100 in FIG. 1.

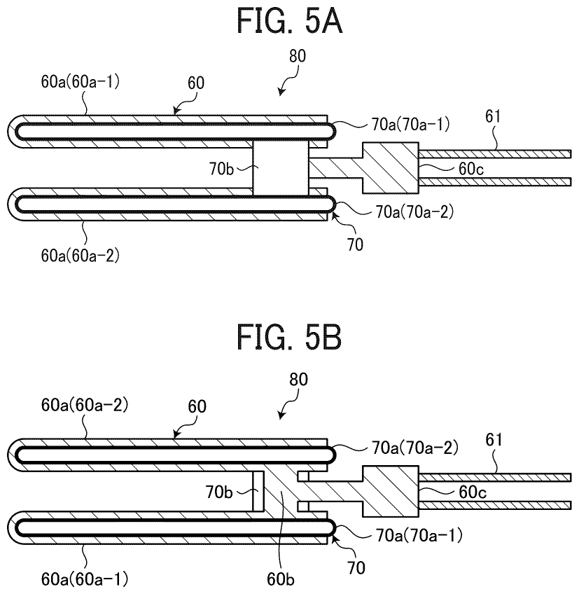

As illustrated in FIGS. 1 and 2, the liquid discharge head 100 includes a nozzle plate 1, a channel plate 2, and a diaphragm 3 as a wall member that are stacked one on another and bonded to each other. The liquid discharge head 100 includes a piezoelectric actuator 11 that displaces a vibration region 30 (vibration plate) of the diaphragm 3, a common channel member 20 that is a housing member, a heater 60, and a heater holder 70. The common channel member 20 also serves as a frame member of the liquid discharge head 100. Although described in detail later, the heater holder 70 is a leaf spring member and is an intermediary component for attaching the heater 60 to the common channel member 20. The heater 60 is held in a predetermined posture by being attached to the heater holder 70 (see FIGS. 5A and 5B). In a case where the heater holder 70 is formed of a metal leaf spring member, insulation processing is applied to the heater holder 70 or an opposing surface of the heater 60 facing the heater holder 70. A channel member 90 includes the common channel member 20, the heater 60, and the heater holder 70.

The nozzle plate 1 has four nozzle rows in which multiple nozzles 4 for discharging liquid is arranged.

The channel plate 2 includes multiple pressure chambers 6, one or more individual supply channels 7, and one or more intermediate supply channels 8. The multiple pressure chambers 6 respectively communicates with the multiple nozzles 4. The one or more individual supply channels 7 also serve as fluid restrictors and communicate with the multiple pressure chambers 6. One or more of the intermediate supply channels 8 respectively communicate with one or more of the individual supply channels 7.

The diaphragm 3 includes multiple deformable vibration regions 30 (vibration plate) forming wall surfaces of pressure chambers 6 of the channel plate 2. Here, the diaphragm 3 has a three-layer structure (not limited), and includes a first layer, a second layer, and a third layer arranged in this order from the channel plate 2 side. The first layer forms a thin portion. The second layer and the third layer form a thick portion. The vibration region 30, which is deformable (displaceable), is formed in a portion corresponding to the individual pressure chamber 6 in the first layer.

In the liquid discharge head 100, the piezoelectric actuator 11 includes electromechanical transducer element as a driving device (actuator device or pressure generator) to deform the vibration regions 30 of the diaphragm 3. The piezoelectric actuator 11 is disposed at a first side of the diaphragm 3 opposite a second side of the diaphragm 3 facing the pressure chambers 6.

In the piezoelectric actuator 11, a piezoelectric member bonded onto a base 13 is groove-processed by half cut dicing to form a desired number of pillar-shaped piezoelectric elements 12 in a comb shape at predetermined intervals in the nozzle array direction. The piezoelectric element 12 is joined to a convex portion 30a that is a thick portion formed on the vibration region 30 of the diaphragm 3.

Two rows of piezoelectric elements 12 are arranged in one piezoelectric actuator 11. Accordingly, one piezoelectric actuator 11 discharges a desired liquid from the four rows of nozzles 4.

The piezoelectric element 12 includes piezoelectric layers and internal electrodes alternately stacked on each other. Each internal electrode is led out to an end surface and connected to an external electrode (end surface electrode). The external electrode is connected with a flexible wiring member 15. A driver integrated circuit (IC) (drive circuit) 16 is mounted on the flexible wiring member 15.

The common channel member 20 defines a common supply channel 10. The common supply channel 10 communicates with the intermediate supply channel 8 via an opening 9 in the diaphragm 3.

In the liquid discharge head 100, for example, the voltage to be applied to the piezoelectric element 12 is lowered from a reference potential (intermediate potential) so that the piezoelectric element 12 contracts to pull the vibration region 30 of the diaphragm 3 to increase a volume of the pressure chamber 6. As a result, liquid flows into the pressure chamber 6.

When the voltage applied to the piezoelectric element 12 is raised, the piezoelectric element 12 expands in a stacking of the piezoelectric element 12. The vibration region 30 of the diaphragm 3 deforms in a direction toward the nozzle 4 and contracts the volume of the pressure chambers 6. As a result, the liquid in the pressure chambers 6 is squeezed out of the nozzle 4 so that the liquid is discharged from the nozzle 4.

A driving method of the head is not limited to the above example (pull-push), and pulling, pushing, and the like, can be performed depending on how a drive waveform is provided.

Next, the common channel member 20 and the heater 60 will be described.

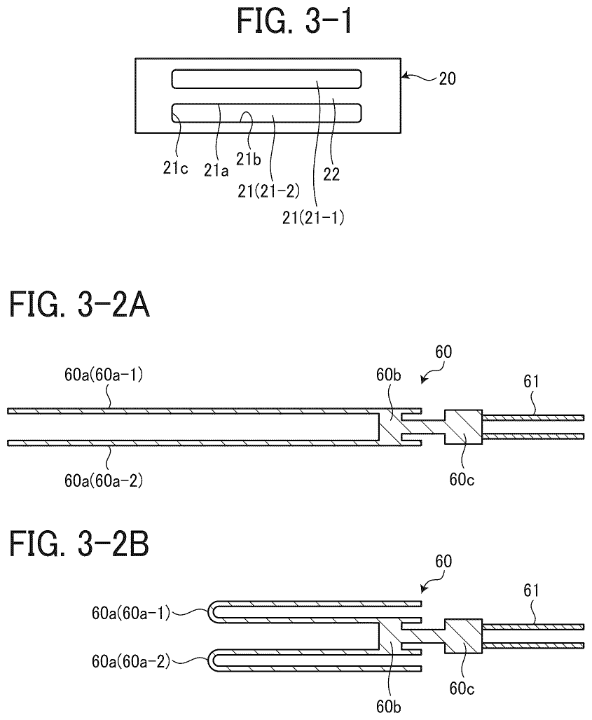

FIG. 3-1 is a plan view schematically illustrating the common channel member 20. As illustrated in FIG. 3-1, the common channel member 20 is provided with two elongated openings 21 (21-1, 21-2) into which the two piezoelectric actuators 11 (11-1, 11-2) are inserted, respectively, along the nozzle array direction.

FIGS. 3-2A and 3-2B are plan views schematically illustrating the heater 60. FIG. 3-2A illustrates an aspect before the heater 60 is attached to the common channel member 20. FIG. 3-2B illustrates an aspect when the heater 60 is attached to the common channel member 20. The heater 60 transfers heat from two heater portions 60a (60a-1, 60a-2) serving as heat generating surfaces divided for each opening 21 (21-1, 21-2) of the common channel member 20. The heater 60 includes two heater portions 60a (60a-1, 60a-2) disposed so as to extend along inner wall surfaces 21a and 21b in a longitudinal direction and an inner wall surface 21c in a lateral direction of the opening 21 (21-1, 21-2). Here, each heater portion 60a is disposed along the other inner wall surface 21b in the longitudinal direction from the one inner wall surface 21a in the longitudinal direction through the one inner wall surface 21c in the lateral direction. That is, the two elongated openings 21 (21-1, 21-2) of the common channel member 20 are attachment portions to which the heater 60 (two heater portions 60a (60a-1, 60a-2)) is attached on the side surface.

These two heater portions 60a (60a-1, 60a-2) are bridged by a bridge portion 60b attached to a partition wall 22 between the openings 21 (21-1, 21-2) of the common channel member 20. The bridge portion 60b constitutes a part of the heat generating surface, and is provided at one end of each of the heater portions 60a so as to be orthogonal to the heater portions 60a.

The heater 60 is continuously provided with a lead-out portion 60c extending from the bridge portion 60b to the outside of the common channel member 20. A lead wire 61 is connected to the lead-out portion 60c.

Next, a procedure for attaching the heater 60 to the common channel member 20 will be described.

The heater 60 originally has a shape extending in one direction as illustrated in FIG. 3-2A, but when attached, as illustrated in FIGS. 1 and 3-2B, each heater portion 60a (60a-1, 60a-2) of the heater 60 is bent with respect to the bridge portion 60b, and the heater portion 60a (60a-1, 60a-2) is folded back along the wall surfaces 21a to 21c of the opening 21 (21-1, 21-2).

The heater portion 60a (60a-1, 60a-2) of the heater 60 is inserted into the opening 21 (21-1, 21-2) of the common channel member 20, and the bridge portion 60b is attached and installed along the upper surface of the partition wall 22 of the common channel member 20. Thereafter, the heater portion 60a (60a-1, 60a-2) is attached and installed on the wall surfaces 21a to 21c of the opening 21 (21-1, 21-2).

In the heater 60, the length of the bridge portion 60b is much shorter than the length of the opening 21. Therefore, since the heater 60 is bent when the bridge portion 60b is attached to the partition wall 22 of the common channel member 20, it is difficult to attach the heater portion 60a (60a-1, 60a-2) to the elongated opening 21 (21-1, 21-2) of the housing member (common channel member 20).

Accordingly, the heater 60 is attached to the common channel member 20 with the heater holder 70 interposed therebetween.

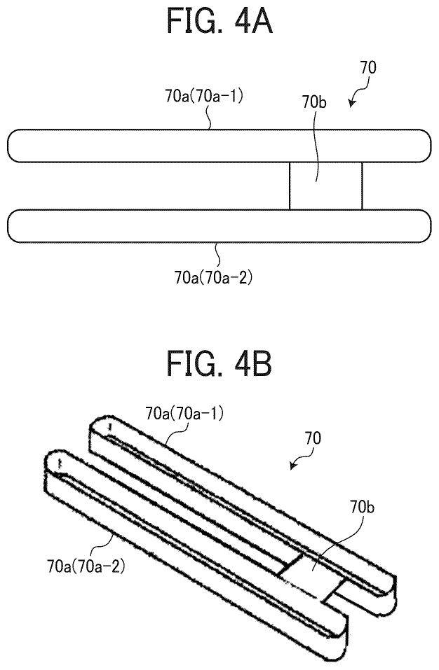

Here, FIGS. 4A and 4B are views illustrating an example of the heater holder 70. FIG. 4A is a plan view of the heater holder 70, and FIG. 4B is a perspective view of the heater holder 70.

As illustrated in FIGS. 4A and 4B, each holding portion 70a (70a-1, 70a-2) of the heater holder 70 is formed by forming an elongated belt-shaped thin plate in a ring shape so as to have substantially the same shape as the opening 21 (21-1, 21-2) of the common channel member 20, and has a hollow shape. In addition, the heater holder 70 has a plate-like elastic portion 70b that elastically connects one end of each of the two holding portions 70a (70a-1, 70a-2) together at a position facing the bridge portion 60b when attached to the heater 60. The heater portions 60a (60a-1, 60a-2) of the heater 60 are provided at a position facing the elastic portion 70b. The heater 60 is pressed against the two elongated openings 21 (21-1, 21-2) by the elastic force generated by the elastic portion 70b. By connecting the two holding portions 70a (70a-1, 70a-2) by the elastic portion 70b, the assembling operation time can be shortened.

The elastic force generated by the elastic portion 70b acts to hold the position of the heater holder 70 with respect to the two elongated openings 21 (21-1, 21-2). The heater holder 70 does not need to be completely secured, and may be held to the extent that it does not fall off. As a result, assemble-ability at the time of manufacturing is improved.

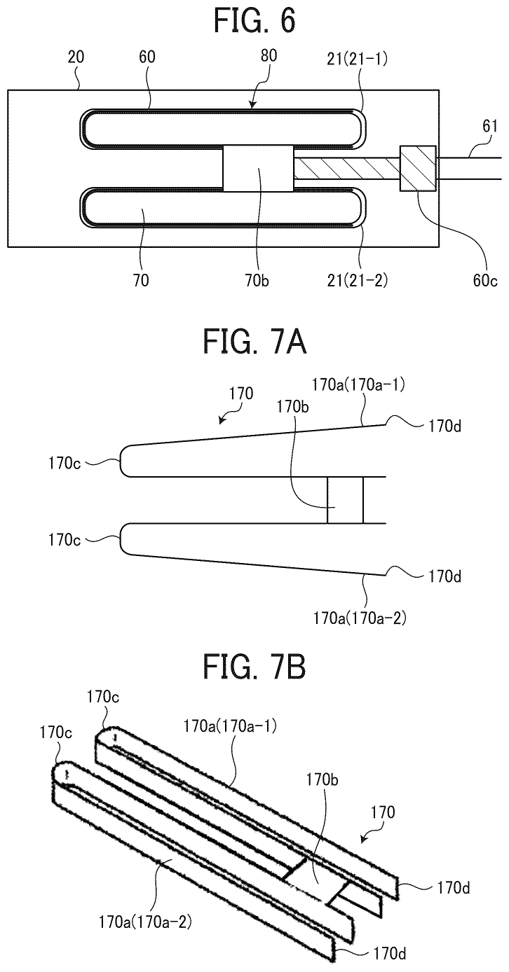

Here, FIGS. 5A and 5B are plan views illustrating an attachment member 80 obtained by attaching the heater 60 to the heater holder 70. FIG. 6 is a plan view illustrating a state in which the attachment member 80 is set in the openings 21 of the common channel member 20.

As illustrated in FIGS. 5A and 5B, the two heater portions 60a (60a-1, 60a-2) of the heater 60 are attached in a folded state along the two holding portions 70a (70a-1, 70a-2) of the heater holder 70, respectively, to become the attachment member 80.

The two heater portions 60a (60a-1, 60a-2) of the heater 60 may be respectively attached to the two holding portions 70a (70a-1, 70a-2) of the heater holder 70 with adhesive or a double-sided tape to form the attachment member 80.

As illustrated in FIG. 6, the attachment member 80 obtained by attaching the two heater portions 60a (60a-1, 60a-2) of the heater 60 to the heater holder 70 is directly set in the openings 21 (21-1, 21-2) of the common channel member 20. In this case, since the holding portions 70a (70a-1, 70a-2) including the attachment member 80 have substantially the same shapes as the openings 21 (21-1, 21-2) of the common channel member 20, the attachment member 80 can be easily set by simply dropping the attachment member into the openings 21 (21-1, 21-2).

As described above, since the heater 60 can be set to the common channel member 20 without being directly attached to the common channel member using an adhesive, workability when the heater is attached to the common channel member is very high. In addition, since the adhesive of the heater 60 does not adhere to the common channel member 20, it is possible to save time and effort to remove the adhesive, so that the common channel member 20 can be easily reused.

A heat transfer assist medium that promotes heat transfer, such as heat transfer grease or a heat transfer sheet, may be interposed on the contact surface between the attachment member 80 and the openings 21 (21-1, 21-2). In this way, the heat of the heater 60 can be efficiently transferred to the common channel member 20.

As described above, according to the present embodiment, it is possible to improve workability and reusability of the heater when the heater is attached to the common channel member.

### Second Embodiment

A description is given below of a second embodiment of the present disclosure.

The second embodiment is different from the first embodiment in the shape of the heater holder. In the following description of the second embodiment, descriptions of elements identical or similar to those in the first embodiment are omitted, and differences from the first embodiment are described.

Here, FIGS. 7A and 7B are plan views illustrating, as an example, a heater holder 170 according to the second embodiment. FIG. 7A is a plan view illustrating a shape of a heater holder 170 in a state before being set in the openings 21. FIG. 7B is a perspective view illustrating a shape of the heater holder 170 in a state of being set in the openings 21. As illustrated in FIG. 7A, each holding portion 170a (170a-1, 170a-2) of the heater holder 170 includes a U-shaped folded portion 170c having substantially the same shape as one end of the opening 21 in the longitudinal direction in a state before being set in the openings 21. The holding portion 170a (170a-1, 170a-2) is formed in a tapered shape so as to be away from the elastic portion 170b from the U-shaped folded portion 170c toward the end 170d. The heater holder 170 includes an elastic portion 170b that elastically connects the two holding portions 170a (170a-1, 170a-2) at a position facing the bridge portion 60b when attached to the heater 60. By connecting the two holding portions 170a (170a-1, 170a-2) by the elastic portion 170b, the assembling operation time can be shortened.

Two heater portions 60a (60a-1, 60a-2) of the heater 60 are attached to the two holding portions 170a (170a-1, 170a-2) of the heater holder 170 having such a configuration in a folded state along the two holding portions.

Here, since the holding portion 170a (170a-1, 170a-2) of the heater holder 170 is formed in a tapered shape so as to be away from the elastic portion 170b as it goes from the U-shaped folded portion 170c toward the end 170d, when the heater holder 170 is set in the opening 21 (21-1, 21-2) of the common channel member 20, the holding portion 170a (170a-1, 170a-2) of the heater holder 170 can maintain a state of being biased to the opening 21 (21-1, 21-2) of the common channel member 20 by spring property, and the thermal resistance between the heater 60 and the common channel member 20 can be reduced. As illustrated in FIG. 7B, in a state where the two holding portions 170a (170a-1, 170a-2) of the heater holder 170 are set in the openings 21 of the common channel member 20, the tapered shapes become straight following the shapes of the openings 21.

### Third Embodiment

A description is given below of a third embodiment of the present disclosure.

The third embodiment is different from the first embodiment and the second embodiment in a shape of a partition wall between openings 21 (21-1, 21-2) of a common channel member 20. In the following description of the third embodiment, descriptions of elements identical or similar to those in the first embodiment or the second embodiment are omitted, and differences from the first embodiment and the second embodiment are described.

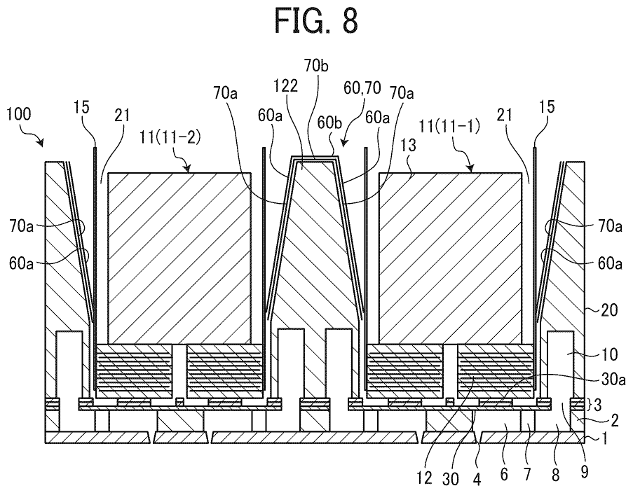

FIG. 8 is an explanatory cross-sectional view illustrating the liquid discharge head 100 according to the third embodiment. FIG. 8 is an explanatory cross-sectional view taken along a direction orthogonal to a nozzle array direction corresponding to a line X1-X1 of the liquid discharge head 100 of FIG. 1.

As illustrated in FIG. 8, a partition wall 122 between the openings 21 (21-1, 21-2) of the common channel member 20 is formed in a tapered shape inclined (tapered) toward a distal end.

The heater holder 70 is formed in a shape conforming to the tapered shape of the partition wall 122 between the openings 21 (21-1, 21-2) of the common channel member 20.

In this way, it is possible to improve workability when the heater holder 70 to which the heater 60 is attached is set in the opening 21 (21-1, 21-2) of the common channel member 20.

### Fourth Embodiment

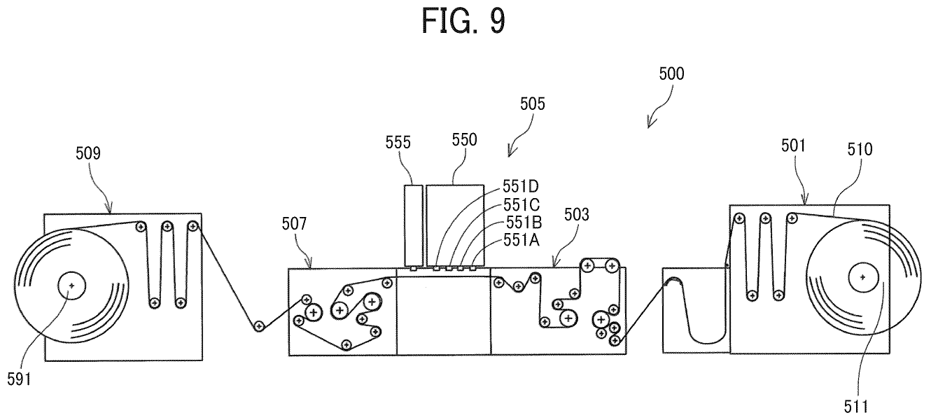

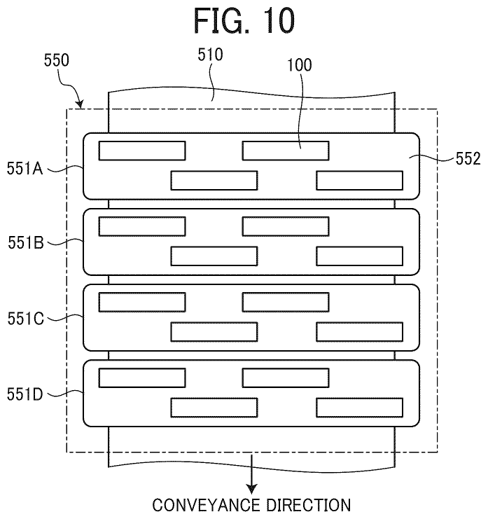

Next, an example of the liquid discharge apparatus will be described with reference to FIGS. 9 and 10. FIG. 9 is an explanatory schematic view of the liquid discharge apparatus. FIG. 10 is an explanatory plan view of an example of the head unit of the liquid discharge apparatus.

A printer 500 serving as the liquid discharge apparatus includes a feeder 501 to feed a continuous medium 510, such as a rolled sheet, a guide conveyor 503 to guide and convey the continuous medium 510, fed from the feeder 501, to a printing unit 505, the printing unit 505 to discharge a liquid onto the continuous medium 510 to form an image on the continuous medium 510, a dryer 507 to dry the continuous medium 510, and an ejector 509 to eject the continuous medium 510.

The continuous medium 510 is fed from a winding roller 511 of the feeder 501, guided and conveyed with rollers of the feeder 501, the guide conveyor 503, the dryer 507, and the ejector 509, and wound around a take-up roller 591 of the ejector 509.

In the printing unit 505, the continuous medium 510 is conveyed so as to face a head unit 550 and a head unit 555. The head unit 550 discharges the liquid onto the continuous medium 510 to form an image on the continuous medium 510. The head unit 555 discharges a treatment liquid onto the continuous medium 510 to perform post-treatment on the continuous medium 510 with the treatment liquid.

The head unit 550 includes, for example, four-color full-line head arrays 551A, 551B, 551C, and 551D from an upstream side in a conveyance direction of the continuous medium 510. Hereinafter, the four-color full-line head arrays 551A, 551B, 551C, and 551D are collectively referred to as “head arrays 551” unless colors are distinguished.

The head arrays 551 are liquid discharge devices to respectively discharge liquids of black (K), cyan (C), magenta (M), and yellow (Y) onto the continuous medium 510 conveyed in the conveyance direction. The number and types of color are not limited to these colors and may be any other number and types.

In each head array 551, for example, liquid discharge heads 100 are staggered on a base 552 to form the head array 551, but is not limited to such a configuration.

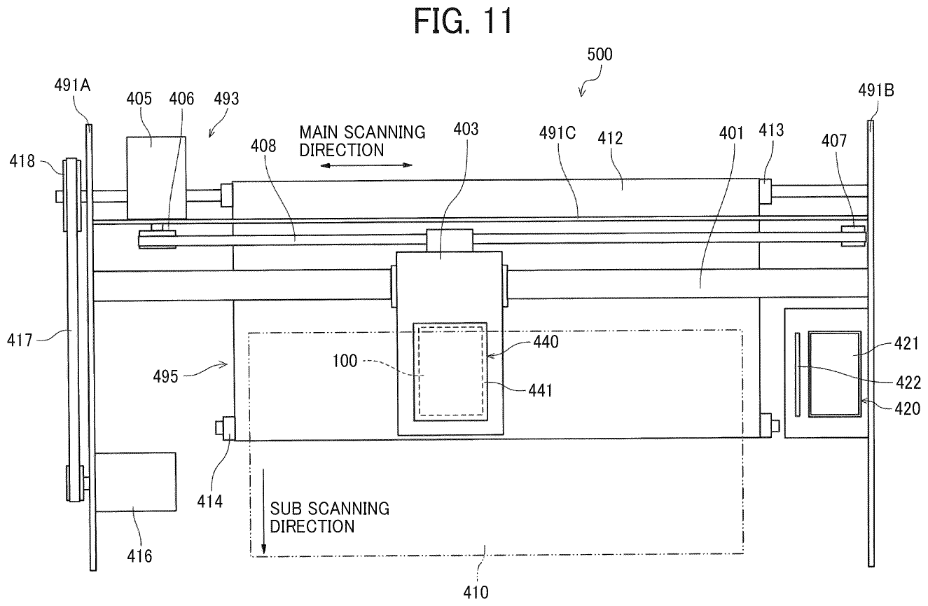

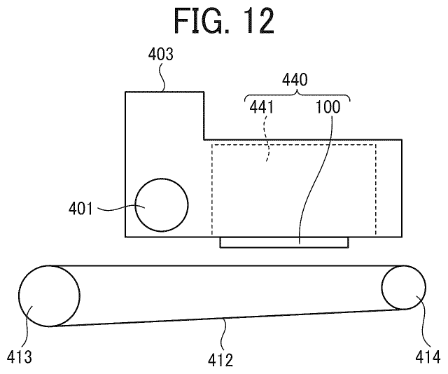

Next, another example of the printer 500 serving as a liquid discharge apparatus according to another embodiment of the present disclosure is described with reference to FIGS. 11 and 12. FIG. 11 is an explanatory plan view of a main part of the printer 500. FIG. 12 is an explanatory side view of a main part of the printer 500.

The printer 500 is a serial head apparatus, and the carriage 403 is reciprocally moved in a main scanning direction by a main scanning moving mechanism 493. The main scanning moving mechanism 493 includes, for example, a guide 401, a main scanning motor 405, and a timing belt 408. The guide 401 is bridged between a left-side plate 491A and a right-side plate 491B to moveably hold the carriage 403. The main scanning motor 405 reciprocally moves the carriage 403 in the main scanning direction via the timing belt 408 bridged between a drive pulley 406 and a driven pulley 407.

The carriage 403 is equipped with a liquid discharge unit 440. The liquid discharge head 100 and a head tank 441 forms the liquid discharge unit 440 as a single unit. The liquid discharge head 100 of the liquid discharge unit 440 discharges color liquids of, for example, yellow (Y), cyan (C), magenta (M), and black (K). The liquid discharge head 100 includes a nozzle array including multiple nozzles arrayed in a sub scanning direction perpendicular to the main scanning direction and is mounted so that a discharge direction is downward.

The liquid discharge head 100 is connected to a liquid circulation device as described above so that a liquid of a desired color is circulated and supplied.

The printer 500 includes a conveyor 495 to convey a sheet 410. The conveyor 495 includes a conveyance belt 412 as a conveyor and a sub scanning motor 416 to drive the conveyance belt 412.

The conveyance belt 412 attracts the sheet 410 and conveys the sheet 410 at a position facing the liquid discharge head 100. The conveyance belt 412 is an endless belt looped around a conveyance roller 413 and a tension roller 414. The attraction can be performed by electrostatic attraction, air suction, or the like.

The conveyance belt 412 circumferentially moves in the sub scanning direction as the conveyance roller 413 is rotationally driven by the sub scanning motor 416 via a timing belt 417 and a timing pulley 418.

At one side in the main scanning direction of the carriage 403, a maintenance recovery mechanism 420 to maintain the liquid discharge head 100 in good condition is disposed on a lateral side of the conveyance belt 412.

The maintenance recovery mechanism 420 includes, for example, a cap 421 to cap a nozzle surface (a surface on which a nozzle is formed) of the liquid discharge head 100, a wiper 422 to wipe the nozzle surface.

The main scanning moving mechanism 493, the maintenance recovery mechanism 420, and the conveyor 495 are mounted to a housing that includes the left-side plate 491A, the right-side plate 491B, and a rear-side plate 491C.

In the printer 500 thus configured, the sheet 410 is conveyed on and attracted to the conveyance belt 412 and is conveyed in the sub scanning direction by a cyclic rotation of the conveyance belt 412.

The liquid discharge head 100 is driven in response to image signals while the carriage 403 moves in the main scanning direction, to discharge liquid to the sheet 410 stopped, thus forming an image on the sheet 410.

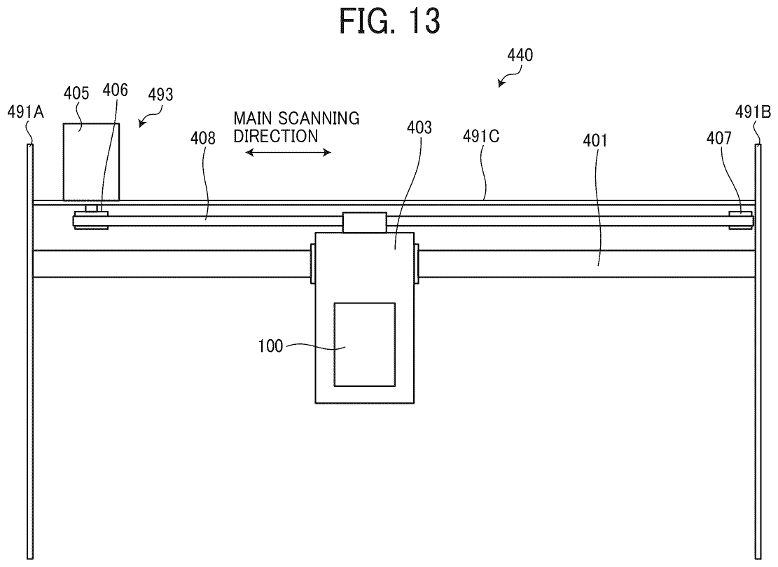

Another liquid discharge unit is described below with reference to FIG. 13 is an explanatory plan view of a main part of another example of the liquid discharge unit.

The liquid discharge unit 440 includes a housing, the main scanning moving mechanism 493, the carriage 403, and the liquid discharge head 100 among components of the printer 500 in FIG. 13. The left-side plate 491A, the right-side plate 491B, and the rear-side plate 491C constitute the housing.

The liquid discharge unit can be configured such that the maintenance recovery mechanism 420 described above is further attached to, for example, the right-side plate 491B of the liquid discharge unit 440.

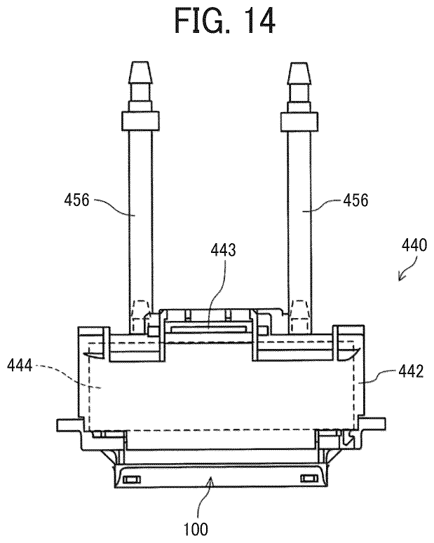

Next, still another example of the liquid discharge unit will be described with reference to FIG. 14. FIG. 14 is an explanatory front view of the liquid discharge unit.

The liquid discharge unit 440 includes the liquid discharge head 100 to which a channel part 444 is attached, and a tube 456 connected to the channel part 444.

The channel part 444 is disposed inside a cover 442. Alternatively, the liquid discharge unit 440 may include the head tank 441 instead of the channel part 444. A connector 443 electrically connected with the liquid discharge head 100 is provided on an upper part of the channel part 444.

In the present embodiment, discharged liquid is not limited to a particular liquid as long as the liquid has a viscosity or surface tension to be discharged from a head (liquid discharge head). However, preferably, the viscosity of the liquid is not greater than 30 mPa·s under ordinary temperature and ordinary pressure or by heating or cooling. Specific examples of the liquid include a solution, a suspension, or an emulsion including, for example, a solvent, such as water or an organic solvent, a colorant, such as dye or pigment, a functionality imparting material, such as a polymerizable compound, a resin, a surfactant, a biocompatible material, such as deoxyribonucleic acid (DNA), amino acid, protein, or calcium, and an edible material, such as a natural colorant. Such a solution, a suspension, or an emulsion can be used for, e.g., inkjet ink, surface treatment solution, a liquid for forming components of electronic element or light-emitting element or a resist pattern of electronic circuit, or a material solution for three-dimensional fabrication.

Examples of an energy source to discharge liquid include a piezoelectric actuator (a stacked piezoelectric element or a thin-film piezoelectric element), a thermal actuator that employs an electrothermal conversion element, such as a heating resistor, and an electrostatic actuator including a diaphragm and opposed electrodes.

The “liquid discharge unit” is an assembly of parts relating to liquid discharge. The term “liquid discharge unit” represents a structure including the head and a functional part(s) or unit(s) combined to the liquid discharge head to form a single unit. For example, the “liquid discharge unit” includes a combination of the liquid discharge head with at least one of a head tank, a carriage, a supply mechanism, a maintenance recovery mechanism, a main scanning moving mechanism, or a liquid circulation device.

Examples of the “single unit” include a combination in which the liquid discharge head and one or more functional parts and units are secured to each other through, e.g., fastening, bonding, or engaging, and a combination in which one of the head and the functional parts and units is movably held by another. The liquid discharge head may be detachably attached to the functional part(s) or unit(s) each other.

For example, the liquid discharge head and the head tank may form the liquid discharge unit as a single unit. Alternatively, the liquid discharge head and the head tank coupled (connected) with a tube or the like may form the liquid discharge unit as a single unit. A unit including a filter may be added at a position between the head tank and the liquid discharge head of the liquid discharge unit.

In another example, the liquid discharge head and the carriage may form the liquid discharge unit as a single unit.

The liquid discharge head is movably held on the guide that constitutes a part of the scanning moving mechanism. Thus, the liquid discharge head and the scanning moving mechanism may be formed into a single unit to be the liquid discharge unit. The liquid discharge head may include the head, the carriage, and the main scanning moving mechanism that form a single unit.

A cap that forms a part of the maintenance recovery mechanism may be secured to the carriage mounting the liquid discharge head so that the liquid discharge head, the carriage, and the maintenance recovery mechanism are formed into a single unit as the liquid discharge unit.

Further, the liquid discharge unit includes tubes connected to the head tank or the liquid discharge head mounting a channel part so that the liquid discharge head and the supply mechanism form a single unit. A liquid in a liquid reservoir source such as an ink cartridge is supplied to the liquid discharge head through this tube.

The main scanning moving mechanism may include the guide alone. The supply mechanism also includes a single tube alone or a single loading unit alone.

The term “liquid discharge apparatus” used herein also represents an apparatus including the liquid discharge head or the liquid discharge unit to drive the liquid discharge head to discharge liquid. The liquid discharge apparatus includes an apparatus that can discharge the liquid to a material to which liquid can adhere or an apparatus that discharges liquid toward gas or into liquid.

The “liquid discharge apparatus” can also include a unit for feeding, conveying, and ejecting a material to which liquid can adhere, as well as a pretreatment apparatus, and a post-treatment apparatus.

The “liquid discharge apparatus” may be, for example, an image forming apparatus to form an image on a sheet by discharging ink, or a three-dimensional fabrication apparatus to discharge fabrication liquid to a powder layer in which powder material is formed in layers, so as to form a three-dimensional object.

The “liquid discharge apparatus” is not limited to an apparatus that discharges liquid to visualize meaningful images such as letters or figures. For example, the liquid discharge apparatus may be an apparatus that forms patterns having no meaning or an apparatus that fabricates three-dimensional images.

The term “material to which liquid can adhere” described above represents a material to which liquid is at least temporarily adhered, a material to which liquid is adhered and fixed, or a material into which the liquid is adhered to permeate. Specific examples of the “medium onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of the “material to which liquid can adhere” include any materials to which the liquid can adhere even temporarily, such as paper, thread, fiber, fabric, leather, metal, plastic, glass, wood, and ceramic.

The “liquid discharge apparatus” may be an apparatus that allows the liquid discharge head and a material to which liquid can adhere to relatively move. However, the liquid discharge apparatus is not limited to such an apparatus. For example, the liquid discharge apparatus may be a serial head apparatus that moves the liquid discharge head or a line head apparatus that does not move the liquid discharge head.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particles of the raw material.

The terms “image formation”, “recording”, “printing”, “image printing”, and “fabricating” used herein may be used synonymously with each other.

A channel member includes: a common channel member (20) including: a common channel; and an attachment portion (21), in the common channel member; and a heater (60) having a heat generating surface to transfer heat from the heat generating surface to the common channel member (20); and a heater holder (70) to hold the heater (60), and the heater holder (70) holding the heater is attached to the attachment portion (21) of the common channel member (20).

The heater holder holds the heater that is attached to the heater holder with adhesive or a double-sided tape.

The attachment portion (21) has multiple openings (21), the heater includes: multiple heater portions (60a); and a bridge portion (60b) bridging the multiple heater portions (60a), the heater holder (70) includes: multiple holding portions (70a) to respectively hold the multiple heater portions (60a); and an elastic portion (70b) elastically connecting the multiple holding portions (70a), the bridge portion (60b) of the heater faces the elastic portion when the multiple holding portions (70a) respectively hold the multiple heater portions (60a), and the elastic portion (70b) of the heater holder (70) presses the multiple holding portions (70a) respectively holding the multiple heater portions (60a) against the multiple openings (21). The elastic portion (70b) presses the multiple holding portions (70a) against the multiple openings (21) of the attachment portion. The common channel member includes multiple attachment portions including the attachment portion, and the heater includes multiple heater portions respectively facing the multiple attachment portions.

The attachment portion (21) of the common channel member has multiple openings, and the heater includes multiple heater portions respectively facing the multiple openings of the attachment portion. The multiple heater portions respectively have multiple heat generating surfaces including the heat generating surface, and multiple heat generating surfaces are respectively attached to the multiple openings of the attachment portion. The heater holder includes a leaf spring. The heater holder includes a metal leaf spring, and the heater holder has an opposing surface of the metal leaf spring facing the heater, the opposing surface is insulated.

The channel member further includes: a heat transfer medium interposed between of the multiple holding portions (70a) of the heater holder and the multiple openings of the attachment portion, and the heat transfer medium transfers heat from the heater to the common channel member (20) via the heater holder and the heat transfer medium. The channel member further includes: multiple piezoelectric actuators, and the multiple openings respectively house the multiple piezoelectric actuators.

Each of the multiple holding portions (70a) has a hollow-ring-shaped body of an elongated belt-shaped thin plate, and the hollow-ring-shaped body has the same shape as shapes of the multiple openings.

Each of the multiple holding portions (70a) of the holding portion includes: a U-shaped folded portion at one end of the heater holder, an outer end having a distance between the outer end and the elastic portion, the elastic portion is disposed at another end of the heater holder, the U-shaped folded portion has the same shape as one end of each of the multiple openings, and the distance increases from the U-shaped folded portion toward said another end of the heater holder to form a tapered shape.

The attachment portion (21) has an inner surface having a tapered shape, the heater holder has a tapered shape conforming to the tapered shape of the attachment portion (21), and the heater holder is attached to the attachment portion.

A liquid discharge head includes: the channel member; and a piezoelectric actuator, in the channel member, to discharge a liquid in the common channel from a nozzle.

A liquid discharge apparatus includes: the liquid discharge head, to discharge a liquid in the common channel of the common channel member.

A three-dimensional fabrication apparatus includes: the liquid discharge head, to discharge a liquid, in the common channel of the common channel member, to form a three-dimensional object.

According to the present embodiment, there is an effect that workability when the heater is attached to the common channel member and reusability of the heater can be enhanced.

Aspects of the present embodiment are, for example, as follows.

### Aspect 1

According to Aspect 1, a channel member includes:
a common channel member including a common channel;
a heater that transfers heat from a heat generating surface to the common channel member;
an attachment portion that is provided in the common channel member and to which the heater is attached; and
a heater holder provided in the heater,
the heater being attached to the attachment portion with the heater holder interposed therebetween.

### Aspect 2

According to Aspect 2, in the channel member of Aspect 1,
the heater holder includes two holding portions that hold the heater and an elastic portion that elastically connects the two holding portions,
a part of the heat generating surface of the heater is provided at a position facing the elastic portion, and
the heater held by each of the two holding portions is pressed against the attachment portion by an elastic force generated by the elastic portion of the heater holder.

### Aspect 3

According to Aspect 3, in the channel member of Aspect 2, the elastic force generated by the elastic portion acts so that a position of the heater holder with respect to the attachment portion is held.

### Aspect 4

According to Aspect 4, in the channel member of Aspect 2,
the attachment portion includes multiple attachment portions, and the common channel member includes the multiple attachment portions, and
the heat generating surface includes multiple heat generating surfaces, and the heater includes the multiple heat generating surfaces facing the multiple attachment portions.

### Aspect 5

According to Aspect 5, in the channel member of Aspect 4, the multiple heat generating surfaces is heat generating surfaces divided for each of the multiple attachment portions.

### Aspect 6

According to Aspect 6, in the channel member of Aspect 2, the heater holder is a leaf spring member.

### Aspect 7

According to Aspect 7, in the channel member of Aspect 6,
the heater holder is formed of a metal leaf spring member, and
insulation processing is applied to an opposing surface of the leaf spring member or the heater facing the heater holder.

### Aspect 8

According to Aspect 8, in the channel member of Aspect 2, a heat transfer assist medium that promotes heat transfer is interposed between the heater and an opposing surface of the heater holder facing the heater.

### Aspect 9

According to Aspect 9, in the channel member of Aspect 4, the multiple attachment portions is two openings for housing a piezoelectric actuator.

### Aspect 10

According to Aspect 10, in the channel member of Aspect 9, the holding portion is formed by forming an elongated belt-shaped thin plate in a ring shape so as to have the same shape as each of the two openings, and has a hollow shape.

### Aspect 11

According to Aspect 11, in the channel member of Aspect 9, the holding portion includes a U-shaped folded portion having the same shape as one end of each of the two openings, and is formed in a tapered shape so as to be away from the elastic portion from the folded portion toward the end.

### Aspect 12

According to Aspect 12, in the channel member of any one of Aspect 1 to Aspect 11,
a surface of the common channel member to which the heater is attached has a tapered shape, and
the heater holder has a shape conforming to the tapered shape.

Aspect 13

According to Aspect 13, a liquid discharge head includes:
the channel member of any one of Aspect 1 to Aspect 12; and
a piezoelectric actuator that is provided in the channel member and discharges a desired liquid to the nozzle row.

### Aspect 14

According to Aspect 14, a liquid discharge apparatus includes:
the liquid discharge head of Aspect 13,
the liquid discharge apparatus driving the liquid discharge head to discharge liquid.

### Aspect 15

According to Aspect 15, a three-dimensional fabrication apparatus includes:
the liquid discharge head of Aspect 13,
the three-dimensional fabrication apparatus driving the liquid discharge head to discharge liquid to form a three-dimensional object.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A channel member comprising:
a common channel member including:
a common channel; and
an attachment portion,
in the common channel member; and
a heater having a heat generating surface to transfer heat from the heat generating surface to the common channel member; and
a heater holder to hold the heater,
wherein the heater holder holding the heater is attached to the attachment portion of the common channel member.

2. The channel member according to claim 1,
wherein the heater holder holds the heater that is attached to the heater holder.

3. The channel member according to claim 1,
wherein the attachment portion has multiple openings,
the heater includes:
multiple heater portions; and
a bridge portion bridging the multiple heater portions,
the heater holder includes:
multiple holding portions to respectively hold the multiple heater portions; and
an elastic portion elastically connecting the multiple holding portions,
the bridge portion of the heater faces the elastic portion when the multiple holding portions respectively hold the multiple heater portions, and
the elastic portion of the heater holder presses the multiple holding portions respectively holding the multiple heater portions against the multiple openings.

4. The channel member according to claim 3,
wherein the elastic portion presses the multiple holding portions against the multiple openings of the attachment portion.

5. The channel member according to claim 1,
wherein the common channel member includes multiple attachment portions including the attachment portion, and
the heater includes multiple heater portions respectively facing the multiple attachment portions.

6. The channel member according to claim 1,
wherein the attachment portion of the common channel member has multiple openings, and
the heater includes multiple heater portions respectively facing the multiple openings of the attachment portion.

7. The channel member according to claim 6,
wherein the multiple heater portions respectively have multiple heat generating surfaces including the heat generating surface, and
multiple heat generating surfaces are respectively attached to the multiple openings of the attachment portion.

8. The channel member according to claim 3,
wherein the heater holder includes a leaf spring.

9. The channel member according to claim 8,
wherein the heater holder includes a metal leaf spring, and
the heater holder has an opposing surface of the metal leaf spring facing the heater,
the opposing surface is insulated.

10. The channel member according to claim 3, further comprising:
a heat transfer medium interposed between of the multiple holding portions of the heater holder and the multiple openings of the attachment portion, and
the heat transfer medium transfers heat from the heater to the common channel member via the heater holder and the heat transfer medium.

11. The channel member according to claim 3, further comprising:
multiple piezoelectric actuators,
wherein the multiple openings respectively house the multiple piezoelectric actuators.

12. The channel member according to claim 11,
wherein each of the multiple holding portions has a hollow-ring-shaped body of an elongated belt-shaped thin plate, and
the hollow-ring-shaped body has the same shape as shapes of the multiple openings.

13. The channel member according to claim 11,
wherein each of the multiple holding portions of the heater holder includes:
a U-shaped folded portion at one end of the heater holder,
an outer end having a distance between the outer end and the elastic portion,
the elastic portion is disposed at another end of the heater holder,
the U-shaped folded portion has the same shape as one end of each of the multiple openings, and
the distance increases from the U-shaped folded portion toward said another end of the heater holder to form a tapered shape.

14. The channel member according to claim 1,
wherein the attachment portion has an inner surface having a tapered shape,
the heater holder has a tapered shape conforming to the tapered shape of the attachment portion, and
the heater holder is attached to the attachment portion.

15. A liquid discharge head comprising:
the channel member according to claim 1; and
a piezoelectric actuator, in the channel member, to discharge a liquid in the common channel from a nozzle.

16. A liquid discharge apparatus comprising:
the liquid discharge head according to claim 15, to discharge a liquid in the common channel of the common channel member.

17. A three-dimensional fabrication apparatus comprising:
the liquid discharge head according to claim 15, to discharge a liquid, in the common channel of the common channel member, to form a three-dimensional object.
